(19) United States
(12) Patent Application Publication
(10) Pub. No.: US 2007/0156547 A1
(43) Pub. Date: Jul. 5, 2007

(54) Method, System, Device and Function for Generating and Transferring a Bill

(75) Inventor: Haitao Dai, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/610,862

(22) Filed: Dec. 14, 2006

(30) Foreign Application Priority Data
Dec. 14, 2005 (CN) 200510130533.2

(51) Int. Cl. H04M 15/00; G06Q 40/00; G07F 19/00

(52) U.S. Cl. 705/34; 705/40

(57) ABSTRACT

The present invention provides a method for generating a bill, a method for transferring a bill, a system for transferring a bill, a device for generating the bill, a switching device and a charging collection function (CCF), the main solution of which includes: setting bill transfer configration information according to the bill information units that need to be contained in the bill and generating the bill to be transferred according to the bill transfer configuration information. In accordance with the present invention, the bill information units can be set on the practical demands, so that the generated bill is of configurability, and the record length of the bill become changeable, thereby avoiding the storage and transfer for unnecessary bill information units.

### CROSS-REFERENCE TO RELATED APPLICATION

This application claims the benefit of Chinese Patent Application No. 200510130533.2, which was filed on Dec. 14, 2005, the entire disclosure of which is hereby incorporated herein by reference.

### BACKGROUND OF THE DISCLOSURE

1. Field of the Technology

The present invention relates to network communication technologies, and particularly, to a method for generating a bill, a method for transferring a bill, a system for transferring a bill, a device for generating a bill, a switching device and a Charging Collection Function (CCF).

2. Background of the Invention

Along with developments of telecommunication technologies and services, there will be more and more information to be contained in a bill, and the length of a single bill also continuously increases. For example, a Softswitch generally requires that the IP addresses of the Calling/Called Gateways and Gatekeepers should be recorded in the bill, and along with the service development, the Softswitch will also require other information, such as traffic information, to be recorded in the bill. The information that needs to be recorded in the bill varies with different demands of different countries or regions, or even different operators.

In the prior art, the method for transferring a bill is shown in FIG. 1.

As shown in FIG. 1, a switching device generates a bill containing fixed information, i.e., the length of the bill generated by the switching device is fixed, in other words, the number of the bytes of the bill is not changeable. For example, the length of the bill generated by some switching devices is fixed as 154 bytes.

The switching device buffers the generated bill and timely transfers the buffered bill to a charging gateway, e.g., iGateway Bill (IGWB). The IGWB receives only the bill of the designated length according to the pre-configuration, transforms the received bill as demanded by a billing centre, and then forwards the transformed bill to the billing centre.

In general, different operators' demands for the information that needs to be contained in a bill can not be completely identical, for example, operator A requires that, in a call, the traffic information rather than the IP address information should be recorded in the bill while operator B requires that the information to be recorded in the bill should be the IP address information rather than the traffic information. The inventor found that, because the bill processed by the switching device in the prior art is not configurable, that is, the length of the bill transmitted by the switching device is fixed, to meet the demands of both operator A and operator B, the bill generated by the switching device has to contain not only the traffic information in the call but also the IP address information thereby increasing the length of the bill provided by the switching device, which occupies a lot of storage and network transfer resources of the switching device.

### SUMMARY OF THE INVENTION

The embodiments of the present invention provide a method, a device, a switching device and a CCF for generating a bill to flexibly generate a bill on demand.

In addition, the embodiments of the present invention provide a method and a system for transferring a bill to flexibly transfer a bill as required.

The embodiments of the present invention disclose the following technical solutions.

The embodiments of the present invention disclose a method for generating a bill, including:

setting bill transfer configuration information for indicating at least one bill information unit that need to be contained in a bill; generating a bill, in which the at least one bill information unit that need to be contained in the bill indicated by the bill transfer configuration information are included.

In the above solution, the bill transfer configuration information may include information of the bill information unit; and generating the bill may include: determining at least one bill information unit according to the bill transfer configuration information and generating the bill containing each determined bill information unit.

The above solution may further include: dividing, all the bill information units that can be contained in the bill into at least one bill information group; establishing a correspondence relationship between a bill information unit and a bill information group; the bill transfer configuration information includes information of the bill information group; and generating the bill may include: determining at least one bill information group according to the bill transfer configuration information, determining at least one bill information unit corresponding to the determined at least one bill information group according to the correspondence relationship between a bill information unit and a bill information group, generating the bill, and including in the bill the determined at least one bill information unit and the information of each determined bill information group.

The embodiments of the present invention disclose a method for transferring a bill, applied to a system including a device for generating a bill and a charging gateway, wherein bill transfer configuration information for indicating at least one bill information unit that need to be contained in the bill is set in the device for generating a bill, including: generating the bill, by the device for generating the bill, in which the at least one bill information unit that need to be contained in the bill indicated by the bill transferring configuration information are included, and transferring, by the device for generating the bill, the generated bill to the charging gateway; and analyzing, by the charging gateway, the received bill and acquiring the at least one bill information unit from the received bill.

The embodiments of the present invention disclose a first system for transferring a bill, including:

a device for generating a bill, configured to set bill transfer configuration information for indicating at least one bill information unit that need to be contained in the bill, generate the bill in which the at least one bill information unit that need to be contained in the bill indicated by the bill transfer configuration information are included, and transfer the bill to a charging gateway; and the charging gateway, configured to analyze the received bill and acquire the at least one bill information unit from the received bill.

In the above solution, the bill transfer configuration information may include: information of the bill information unit; and the device for generating the bill may be configured to determine each bill information unit according to the bill transfer configuration information and generate the bill containing each determined bill information unit.

In the above solution, all the bill information units that can be contained in the bill may be divided into at least one bill information group; a correspondence relationship between a bill information unit and a bill information group may be set in the device for generating the bill and the charging gateway; the bill transfer configuration information may include: information of the bill information group; the device for generating the bill may be configured to determine at least one bill information group according to the bill transfer configuration information, determine at least one bill information unit corresponding to the determined at least one bill information group according to the correspondence relationship between the bill information unit and the bill information group, generate the bill, and include in the bill the determined at least one bill information unit and the information of the determined at least one bill information group; and the charging gateway may be configured to determine at least one bill information group according to the information of the at least one bill information group contained in the received bill, acquires from the bill the at least one bill information unit corresponding to the determined at least one bill information group according to the correspondence relationship between the bill information unit and the bill information group.

The embodiments of the present invention disclose a second system for transferring a bill, including: a switching device, configured to set bill transfer configuration information according to at least one bill information unit that need to be contained in the bill, generate the bill, include in the bill the at least one bill information unit that need to be contained in the bill indicated by the bill transfer configuration information, and transfer the bill to a charging gateway; and the charging gateway, configured to analyze the received bill and acquire the at least one bill information unit from the bill.

The embodiments of the present invention disclose a third system for transferring a bill, including: a charging collection function (CCF), configured to set bill transfer configuration information according to at least one bill information unit that need to be contained in the bill, generate the bill, include in the bill the at least one bill information unit to be contained in the bill indicated by the bill transfer configuration information, and transfer the bill to a charging gateway; and the charging gateway, configured to analyze the received bill and acquire the at least one bill information unit from the bill.

In addition, the invention provides a device for generating a bill, including: a module for generating and transferring a bill, configured to set bill transfer configuration information for indicating at least one bill information unit that need to be contained in the bill, generate the bill, include in the bill the at least one bill information unit that need to be contained in the bill indicated by the bill transfer configuration information , and transfer the bill.

The embodiments of the present invention disclose a switching device and a CCF, each of which includes: a module for generating and transferring a bill, configured to set bill transfer configuration information for indicating at least one bill information unit that need to be contained in a bill, generate the bill, include in the bill the at least one bill information unit that need to be contained in the bill indicated by the bill transfer configuration information, and transfer the bill.

As seen from the description of the above technical solutions, in the embodiments of the present invention, a bill information unit to be generated and transferred can be set on a practical specific demand by setting the bill transfer configuration information. So that, the bill stored in a device for generating a bill, such as a switching device, may contain only the bill information units needed, e.g., those needed by an operator, and the bill generated and transferred by the bill generating device can be of configurability and have bill records with variable length, thereby the problem of the fixed bill content existing in the prior art being effectively overcome. In accordance with the embodiments of the present invention, it can be avoided that unnecessary bill information units are stored and occupy network transferring resources during the bill transfer, and thus, the utility rate of the network resources is improved.

### DESCRIPTION OF THE DRAWINGS

FIG. 1 shows a schematic diagram of a method for transferring a bill in the prior art;

FIG. 2 shows a schematic diagram illustrating the correspondence relationship between a bill information unit and a bill information group in accordance with the embodiment of the present invention;

FIG. 3 shows a schematic diagram of information units in a transferred bill in accordance with the embodiment of the present invention; and

FIG. 4 shows a schematic diagram of a system for transferring a bill in accordance with the embodiment of the present invention.

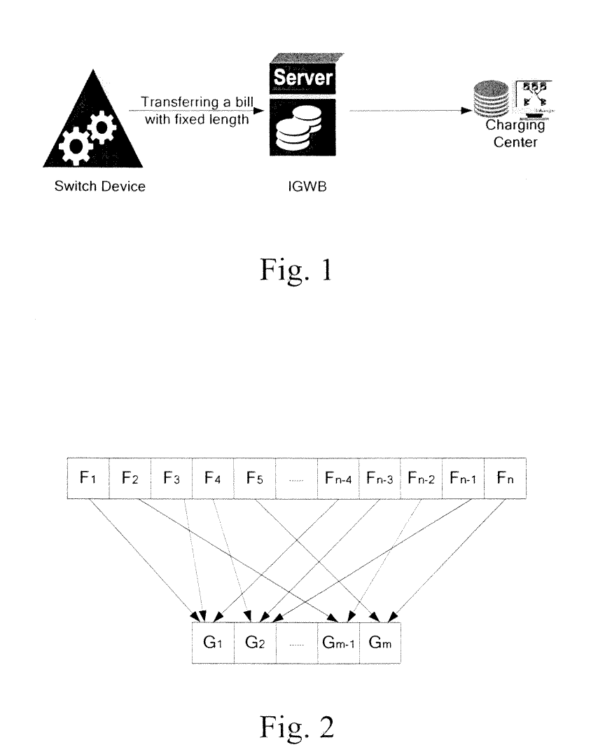

### DETAILED DESCRIPTION OF THE PREFERRED EMBODIMENTS

The embodiments of the present invention provide a method for generating a bill, a method for transferring a bill, a system for transferring a bill, a bill generating device, a switching device and a charging collection function (CCF), the main solution of which includes: setting the bill transfer configuration information in a switching device according to the bill information units that need to be contained in a bill, generating the bill according to the bill transfer configuration information and including each of the bill information units that need to be contained in the bill, and transferring the generated bill. The process of the embodiment of the present invention mainly relates to two entities, a device for generating a bill and a charging gateway, wherein the device for generating a bill sends the self-generated bill to the charging gateway. Herein, devices in a variety of networks, such as a switching device in a Public Switch Telephone Network (PSTN) or a CCF in an IP Multimedia Sub-system (IMS) domain, can be used to implement the device for generating a bill in accordance with the embodiment of the present invention,

The technical solutions provided by the embodiment of the present invention are hereinafter further described based on the main solution and with reference to an example applied to a PSTN network.

The switching device in accordance with the embodiment of the present invention can set bill transfer configuration information according to practical demands, such as the bill information units needed by an operator, and the bill information units are components of a bill, i.e., the specific fields in the bill. According to the bill transfer configuration information, the switching device can determine the bill information units that need to be transferred by the switching device from all the bill information units which can be provided by the bill.

For the convenience of the bill information unit management, in the process of setting the bill transfer configuration information in accordance with the embodiment of the present invention, all the bill information units that can be provided by a bill may first be divided into groups, that is, all the bill information units are divided into multiple bill information groups, in which, the bill information units of the same type may belong to the same bill information group, for example, the calling number and the called number belong to one bill information group. Each bill information unit the bill is able to provide corresponds to one bill information group.

The correspondence relationship between the bill information unit and the bill information group is shown in FIG. 2.

As shown in FIG. 2, suppose that the switching device can provide one bill with n bill information units, F1, F2, F3, . . . , Fn-1, Fn. For example, F1 is a calling number, F3 is a called number, Fn-4 is a charging number, F4 is the time duration of a call, Fn-3 is the starting time of the call, and Fn-1 is the ending time of the call. The switching device puts the bill information units of the same type into one group. Suppose that the switching device divides the bill information units into m bill information groups, G1, G2, . . . , Gm. The number of the bill information units that can be included in each bill information group is fixed, and the sum of the bill information unit numbers of all the bill information groups should be equal to n, i.e., one bill information unit corresponds to only one bill information group. The correspondence relationship between the bill information unit and the bill information group shown in FIG. 2 can be called bill grouping information.

The bill grouping information is stored in the switching device. The bill transfer configuration information is also stored in the switching device, including the information of the bill information groups that need to be transferred to the IGWB, specifically, with regard to each bill information group, the switching device determines whether it needs to be transferred to the IGWB and configures the information for indicating whether it needs to be transferred to the IGWB. Such configured information can be called bill transfer configuration information.

The switching device can determine which bill information group needs to be contained in the bill according to the bill transfer configuration information, and then decide the specific bill information units corresponding to the bill information group according to the correspondence relationship between the bill information unit and the bill information group. Thus, the switching device can determine the specific bill information units that need to be contained in the bill transferred by the switching device.

As shown in FIG. 2, provided that the bill transfer configuration information indicates that only the bill information groups G1 and G2, need to be transferred, according to the bill grouping information, i.e., the correspondence relationship between the bill information unit and the bill information group, the switching device can determine that G1 contains three bill information units, F1 and F3 and Fn-4, and G2 contains three bill information units, F4, Fn-3 and Fn-1. Thus, the switching device can determine that only six bill information units, F1, F3, F4, Fn-3 and Fn-1, need to be contained in the bill to be transferred.

After determining the bill information units that need to be contained in the bill to be transferred, the switching device may use an information element to send the bill to the IGWB. If the switching device groups the bill information units and encapsulates the bill information groups contained in the bill by using the information element, the information element should include: a bill length, identification information of the bill information groups, the lengths of the bill information groups and the bill information units.

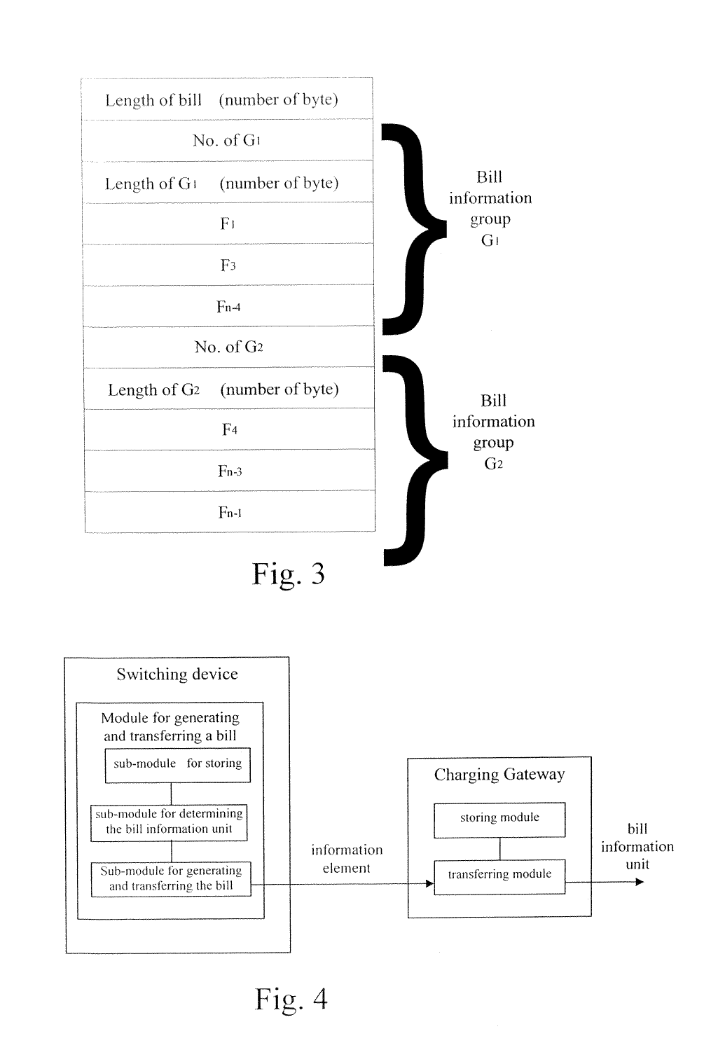

If the bill information groups configured by the switching device include only G1 and G2, the switching device encapsulates the bill to be transferred to the IGWB by using an information element which is shown in FIG. 3.

In FIG. 3, the information element transferred by the switching device to the IGWB includes: the length of the bill, the identification information of G1 (e.g., the number of G1), the length of G1, the bill information units contained in G1, i.e., F1, F3 and Fn-4, the identification information of G2 (e.g., the number of G2), the length of G2, the bill information units contained in G2, i.e., F4, Fn-3 and Fn-1.

If the switching device transfers the bill using the method of grouping the bill information units, the correspondence relationship between the bill information unit and the bill information group is stored in the IGWB. Thus, when receiving the bill transferred from the switching device, the IGWB can determine the bill information units in the received bill according to the self-stored correspondence relationship. For example, when receiving the bill shown in FIG. 3, the IGWB can determine the bill information units contained in the bill, i.e., F1, F3, F4, Fn-4, Fn-3 and Fn-1, according to the correspondence relationship it stored. The IGWB transforms the received bill according to the demand of the billing centre and sends the transformed bill to the billing centre.

If the switching device does not set the bill information (groups, the switching device can directly store the pre-configured bill information units that need to be transferred and send the bill information units to the IGWB with the bill information units encapsulated by the information element. Alternatively, the bill information units may be transferred by other means.

As seen from the above described method for transferring a bill, the bill stored in the switching device contains only the bill information units actually needed, e.g. only the bill information units needed by the operator, thereby avoiding the storing of unnecessary bill information units and the case of unnecessary bill information units occupying network resources in the bill transfer. Thus, the problem of the fixed bill content in the switching device can be effectively overcome, the configurability of the storing and sending of the bill can be realized, making the length of the bill record changeable.

As shown in FIG. 4, the switching device provided by the embodiment of the present invention mainly includes: a module for generating and transferring a bill, used for setting the bill transfer configuration information according to the bill information units that need to be contained in the bill, generating the bill according to the bill transfer configuration information and sending the bill. The bill should include the bill information units that need to be contained in the bill indicated by the bill transfer configuration information.

The functions of the module for generating and transferring the bill are mainly implemented by a sub-module for storing, a sub-module for determining the bill information unit and a sub-module for generating and sending the bill.

If the switching device groups the bill information units, the sub-module for storing is mainly used for storing the bill transfer configuration information and the correspondence relationship between the bill information unit and the bill information group. Meanwhile, the sub-module for determining the bill information unit is mainly used for determining the bill information groups to be contained in the bill according to the bill transfer configuration information stored in the sub-module for storing, and determining the bill information units to be contained in the bill and the bill information groups thereof according to the correspondence relationship between the bill information unit and the bill information group. The sub-module for generating and transferring the bill is mainly used for generating the bill, according to the bill information units and the bill information groups determined by the sub-module module for determining the bill information unit, and sending the bill.

The sub-module for generating and transferring the bill may encapsulate the bill self-generated and send the bill by using the method specifically as described above.

If the switching device does not group the bill information units, the sub-module for storing is mainly used for storing, the bill transfer configuration information which is used for indicating the bill information units that need to be contained in the bill. In such a case, the sub-module for determining the bill information unit only determines the bill information units to be contained in the bill according to the bill transfer configuration information stored in the sub-module for storing, and the sub-module for generating and transferring the bill only generates the bill, according to the bill information units to be contained in the bill determined by the sub-module for determining the bill information unit, and sends the bill.

The switching device provided by the embodiment of the present invention may be not only a switch but also a Softswitch etc.

The bill transfer system provided by the embodiment of the present invention is shown in FIG. 4.

As shown in FIG. 4, the bill transfer system provided by the embodiment of the present invention includes a switching device and a charging gateway.

A module for generating and transferring a bill is set in the switching device, mainly used for setting the bill transfer configuration information according to the bill information units that need to be contained in the bill, generating the bill according to the bill transfer configuration information, and sending the bill to the charging gateway. The specific method for transferring the bill of the switching device and the structure of the module for generating and transferring the bill are as described in the above embodiments.

The charging gateway is mainly used for transferring the corresponding bill information units to the billing centre according to the bill received. The functions of the charging gateway are mainly implemented by a storage module and a transfer module.

If the switching device transfers a bill based on the bill information groups, the storage module of the charging gateway is mainly used for storing the correspondence relationship between the bill information unit and the bill information group which should be the same as the correspondence relationship stored in the switching device. In such a case, the transfer module is mainly used for determining the bill information units contained in the bill received by the charging gateway according to the correspondence relationship stored in the storage module, transforming the bill information units according to the demand of the billing centre, and sending the transformed bill information units to the billing centre.

The above technical solutions based on the PSTN, such as the method for generating a bill, the method for transferring a bill, the system for transferring a bill, can also be applied to other networks, such as an IMS domain. In the case that the present invention is applied to the IMS domain, a CCF is used to function as the device for generating the bill, wherein the specific processing principles are the same as the above mentioned. The processing of the present invention in such a case will not be repeated herein and should fall in the protection scope of this invention.

The foregoing descriptions are only embodiments of the present invention and are not used for limiting the protection scope thereof. Any modification, equivalent replacement or improvement made under the spirit and principle of the present invention is covered by the protection scope of the claims of the invention.

What is claimed is:

1. A method for generating a bill, comprising:
setting bill transfer configuration information for indicating at least one bill information unit that need to be contained in a bill; and
generating the bill containing the at least one bill information unit that need to be contained in the bill indicated by the bill transfer configuration information.

2. The method of claim 1, wherein the bill transfer configuration information includes information of the at least one bill information unit that need to be contained in the bill; and
generating the bill comprises: determining the at least one bill information unit according to the bill transfer configuration information and generating the bill containing each determined bill information unit.

3. The method of claim 1, further comprising: dividing all the bill information units that can be contained in the bill into at least one bill information group; establishing a correspondence relationship between the bill information unit and the bill information group; wherein the bill transfer configuration information comprises information of at least one bill information group that need to be contained in the bill; and
generating the bill comprises: determining the at least one bill information group according to the bill transfer configuration information, determining at least one bill information unit corresponding to the determined at least one bill information group according to the correspondence relationship between the bill information unit and the bill information group, generating the bill, and including in the bill the determined at least one bill information unit and the information of each determined bill information group.

4. The method of claim 3, wherein the information of the bill information group comprises: the identification information of the bill information group and the length of the bill information group.

5. The method of claim 1, wherein generating the bill further comprises: encapsulating the bill as an information element.

6. A method for transferring a bill, applied to a system comprising a device for generating the bill and a charging gateway, wherein bill transfer configuration information for indicating at least one bill information unit that need to be contained in the bill is set in the device for generating the bill, comprising:
the device for generating the bill generating the bill, in which the at least one bill information unit that need to be contained in the bill indicated by the bill transferring configuration information are included, and transferring the generated bill to the charging gateway; and
the charging gateway analyzing the received bill and acquiring the at least one bill information unit from the received bill.

7. The method of claim 6, wherein the bill transfer configuration information comprises information of the at least one bill information unit that need to be contained in the bill; and
generating the bill comprises: determining the at least one bill information unit according to the bill transfer configuration information and generating the bill containing each determined bill information unit.

8. The method of claim 6, further comprising: dividing the bill information units that can be contained in the bill into at least one bill information group; C establishing a correspondence relationship between the bill information unit and the bill information group; setting the correspondence relationship between the bill information unit and the bill information group in the device for generating the bill and the charging gateway; wherein
the bill transfer configuration information comprises information of at least one bill information group that need to be contained in the bill;
generating the bill comprises: determining the at least one bill information group according to the bill transfer configuration information, determining at least one bill information unit corresponding to the determined at least one bill information group according to the correspondence relationship between the bill information unit and the bill information group, generating the bill, and including in the bill the information of the determined at least one bill information unit and the information of each determined bill information group; and
analyzing the bill and acquiring the at least one bill information unit comprises: determining the at least one bill information group contained in the received bill, acquiring from the bill the at least one bill information unit corresponding to the determined at least one bill information group according to the correspondence relationship between the bill information unit and the bill information group.

9. The method of claim 6, wherein transferring the bill to the charging gateway comprises: encapsulating the bill and transferred the encapsulated bill to the charging gateway.

10. A system for transferring a bill, comprising:
device for generating the bill, configured to set bill transfer configuration information for indicating at least one bill information unit that need to be contained in the bill, generate the bill containing the at least one bill information unit that need to be contained in the bill indicated by the bill transfer configuration information, and transfer the bill to a charging gateway; and
the charging gateway, configured to analyze the received bill and acquire the at least one bill information unit from the received bill.

11. The system of claim 10, wherein the bill transfer configuration information comprises: information of the at least one bill information unit that need to be contained in the bill; and
the device for generating the bill is configured to determine the at least one bill information unit according to the bill transfer configuration information and generate the bill containing each determined bill information unit.

12. The system of claim 10, wherein all the bill information units that can be contained in the bill are divided into at least one bill information group; a correspondence relationship between the bill information unit and the bill information group is set in the device for generating the bill and the charging gateway;
the bill transfer configuration information comprises: information of at least one bill information group that need to be contained in the bill,
the device for generating the bill is configured to determine the at least one bill information group according to the bill transfer configuration information, determine the at least one bill information unit corresponding to the determined at least one bill information group according to the correspondence relationship between the bill information unit and the bill information group, generate the bill, and include in the bill the determined at least one bill information unit and the information of each determined bill information group; and
the charging gateway is configured to determine the at least one bill information group contained in the received bill, acquire from the bill the at least one bill information unit corresponding to the determined at least one bill information group according to the correspondence relationship between the bill information unit and the bill information group.

13. A system for transferring a bill, comprising:
a switching device, configured to set bill transfer configuration information according to at least one bill information unit that need to be contained in the bill, generate the bill, include in the bill the at least one bill information unit that need to be contained in the bill indicated by the bill transfer configuration information, and transfer the bill to a charging gateway; and
the charging gateway, configured to analyze the received bill and acquire the at least one bill information unit from the received bill.

14. The system of claim 13, wherein all the bill information units that can be contained in the bill are divided into at least one bill information group; the correspondence relationship between the bill information unit and the bill information group is set in the switching device and the charging gateway:
the bill transfer configuration information comprises: information of at least one bill information group that need to be contained in the bill;
the switching device is configured to determine the at least one bill information group according to the bill transfer configuration information, determine the at least one bill information unit corresponding to the determined at least one bill information group according to the correspondence relationship between the bill information unit and the bill information group, generate the bill, and include in the bill the determined at least one bill information unit and the information of each determined bill information group;
the charging gateway is configured to determine the at least one bill information group contained in the received bill, acquire from the bill the at least one bill information unit corresponding to the determined at least one bill information group according to the correspondence relationship between the bill information unit and the bill information group.

15. A system for transferring a bill, comprising:
charging collection function (CCF), configured to set bill transfer configuration information according to at least one bill information unit that need to be contained in the bill, generate the bill, include in the bill the at least one bill information unit that need to be contained in the bill indicated by the bill transfer configuration information, and transfer the bill to a charging gateway; and
the charging gateway, configured to analyze the received bill and acquire the at least one bill information unit from the received bill.

16. The system of claim 15, wherein all the bill information units that can be contained in the bill are divided into at least one bill information group; a correspondence relationship between the bill information unit and the bill information group is set in the CCF and the charging gateway;
the bill transfer configuration information comprises: information of at least one bill information group that need to be contained in the bill;
the CCF is configured to determine the at least one bill information group according to the bill transfer configuration information, determine the at least one bill information units corresponding to the determined at least one bill information group according to the correspondence relationship between the bill information unit and the bill information group, generate the bill, and include in the bill the determined at least one bill information unit and the information of each determined bill information group; and
the charging gateway is configured to determine at least one bill information group contained in the received bill, acquire from the received bill at least one bill information unit corresponding to the determined at least one bill information group according to the correspondence relationship between the bill information unit and the bill information group.

17. A device for generating a bill, comprising:
module for generating and transferring the bill, configured to set bill transfer configuration information for indicating at least one bill information unit that need to be contained in the bill, generate the bill, include in the bill the at least one bill information unit that need to be contained in the bill indicated by the bill transfer configuration information, and transfer the bill.

18. The device of claim 17, wherein all the bill information units that can be contained in the bill are divided into at least one bill information group; the bill transfer configuration information comprises: information of at least one bill information group that need to be contained it the bill; and
the module for generating and transferring the bill, comprises:
sub-module for storing, configured to store the bill transfer configuration information and a correspondence relationship between the bill information unit and the bill information group;
sub-module for determining the bill information unit, configured to determine at least one bill information group contained in the bill according to the bill transfer configuration information stored in the sub-module for storing and determine at least one bill information unit contained in the bill according to the correspondence relationship between the bill information unit and the bill information group; and
sub-module for generating and transferring the bill, configured to generate the bill, include in the bill the at least one bill information unit determined by the sub-module for determining the bill information unit and the information of each determined bill information group, and transfer the bill.

19. The device of claim 17, wherein the bill transfer configuration information comprises: information of the at least one bill information unit that need to be contained in the bill; and
the module for generating and transferring the bill, comprises:
a sub-module for storing, configured to store the bill transfer configuration information;
sub-module for determining the bill information unit, configured to determine at least one bill information unit contained in the bill according to the bill transfer configuration information stored in the sub-module for storing; and
sub-module for generating and transferring the bill, configured to generate the bill, include in the bill the at least one bill information unit determined by the sub-module for determining the bill information unit, and transfer the bill.

20. A switching device, comprising:
a module for generating and transferring the bill, configured to set bill transfer configuration information for indicating at least one bill information unit that need to be contained in a bill, generate the bill, include in the bill the at least one bill information unit that need to be contained in the bill indicated by the bill transfer configuration information and transfer the bill.

21. The device of claim 20, wherein all the bill information units that can be contained in the bill are divided into at least one bill information group; the bill transfer configuration information comprises: information of at least one bill information group that need to be contained in the bill; and
the module for generating and transferring the bill, comprises:
sub-module for storing, configured to store the bill transfer configuration information and a correspondence relationship between the bill information unit and the bill information group;
sub-module for determining the bill information unit, configured to determine at least one bill information group contained in the bill according to the bill transfer configuration information stored in the sub-module for storing and determine at least one bill information unit contained in the bill according to the correspondence relationship between the bill information unit and the bill information group; and
sub-module for generating and transferring the bill, configured to generate the bill, include in the bill the at least one bill information unit determined by the sub-module for determining the bill information unit and the information of each determined bill information group, and transfer the bill.

22. A charging collection function (CCF), comprising:
a module for generating and transferring a bill, configured to set bill transfer configuration information for indicating at least one bill information unit that need to be contained in the bill, generate the bill, include in the bill the at least one bill information unit that need to be contained in the bill indicated by the bill transfer configuration information, and transfer the bill.

23. The CCF of claim 22, wherein all the bill information units that can be contained in the bill are divided it to at least one bill information group; the bill transfer configuration information comprises: information of at least one bill information group that need to be contained in the bill; and
the module for generating and transferring the bill, comprises:
sub-module for storing, configured to store the bill transfer configuration information and a correspondence relationship between the bill information unit and the bill information group;
sub-module for determining the bill information unit, configured to determine at least one bill information group contained in the bill according to the bill transfer configuration information stored in the sub-module for storing and determine at least one bill information unit contained in the bill according to the correspondence relationship between the bill information unit and the bill information group; and
sub-module for generating and transferring the bill, configured to generate the bill, include in the bill the at least one bill information unit determined by the sub-module for determining the bill information unit and the information of the at least one bill information group, and transfer the bill.
